(19) United States
(12) Patent Application Publication
(10) Pub. No.: US 2012/0218186 A1
(43) Pub. Date: Aug. 30, 2012

(54) 3D Configuration Management System (CMS) Visualization and Management System

(75) Inventor: David Courtney Brock, SR., Gurnee, IL (US)

(73) Assignee: Mr. David Brock, SR., Gurnee, IL (US)

(21) Appl. No.: 13/366,460

(22) Filed: Feb. 6, 2012

Related U.S. Application Data
(60) Provisional application No. 61/447,061, filed on Feb. 27, 2011.

(51) Int. Cl. G06F 3/033; G09G 5/00; G06T 15/00

(52) U.S. Cl. 345/163

(57) ABSTRACT

While 3D visualization is common within numerous other environments (like Movies, Gaming, Traffic reports, Weather reports, etc . . . ) it has only been utilized in the Information Technology (IT) space in so far as displaying virtual rooms or virtual physical environments (i.e. datacenter) and the IT equipment contained in that room. This focus of display may be valuable in some respects; however it is completely different from the concept proposed in this patent. This patent application focuses on a display of the application/service topology in a spatial environment much like a satellite floating in space. The topology is rendered as a collection of configuration items that form a holistic object—regardless of physical location or other physical attributes.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, TABLES, COMPUTER PROGRAM

Not Applicable

### BACKGROUND OF INVENTION

Where as in complex Information Technology infrastructures, it can be very difficult to visualize the system topology of servers, network, storage, etc. that comprise the linked dependencies that enable application or service functions. In a world where shared services are enabling reuse and efficiencies by reducing redundant infrastructure and software, coupled with virtualization technology—applications and services are now more highly linked, dynamic and interdependent. Thus more complicated to manage.

This complex topology environment has created a void or deficiency within the management tool space to properly display or visualize the full scope of the infrastructure and all of the dependencies. Tabular displays and 2-Dimentional topology maps fall short of enabling a holistic display of the infrastructure. What is needed is a full functioning 3D display that dynamically renders the topology (simple structures or very large complex structures), coupled with a robust overlay of specific information (Heads-Up Display) to enrich the information and effectiveness.

Additionally, the ability to share information within a collaboration rich environment—where many users are seeing the same information, the same topology as the primary driver (session control leader)—is incredibly effective in the resolution of application or infrastructure problems because it enhances the ability of all interested parties to see and comment on holistic or individual components.

This invention was created to address the complexity of displaying objects, accounting for relationship between objects and the ability to use this display to assist in the visualization of related objects. During normal conditions as well as during application/service disruptions—having the complete topology visible and extensive data about each object can aid in the swift determination of the failure point and the impact of the failure to the larger use (application/service function).

### BRIEF SUMMARY OF THE INVENTION

This invention enables the ability to visualize complex computer systems and software application topologies and dependent relationships within a boundless, unrestricted spatial environment. Simple and complex topologies are rendered to the computer user's web browser as ‘floating’ objects in an unlimited space environment. The utility allows for a complete, ‘rotating’ view of objects where significant data or details about each object or the collection of objects is displayed on or around the objects themselves as well as on a transparent display facility that overlays the 3D visualization—also known as a Heads-Up Display (HUD). This complete display allows for a primary rendering of the objects and relationship while supplying detailed information overlay capability. The utility further enables a collaborative environment by allowing one user to command the view while many other users join the view and have their visualization controlled by the command instance. Single objects (servers, network, etc . . . ) known as Configuration Items may also be viewed in the same manner

### BRIEF DESCRIPTION OF THE SEVERAL VIEWS OF THE DRAWING

Screen image 1A shows an example of the Heads-Up Display (HUD). The HUD only displays limited information until an infrastructure component of group of components (applications, services, business processes, etc . . . ) is selected. The HUD ‘floats’ over the entire screen and can be dimmed or completely faded from view. It is a transparent overlay that allows the 3D image(s) to be seen at all times. The HUD has five Areas:

Common Information Display—Misc. data is displayed in this area pertaining to the HUD status or objects selected from the Object Selection Area.

Object Selection—Application, Services, Processes, Components are listed for selection.

Main 3D Display—The main 3D viewing area—However objects may be viewed within the entire screen and not just within this area.

Object Movement Control—Objects can be moved around the screen using the control functions as well as using the mouse and keyboard actions.

Session Command Control—This area enabled the ability for users to Join an existing control session, Take Control, release Control or begin a new control session.

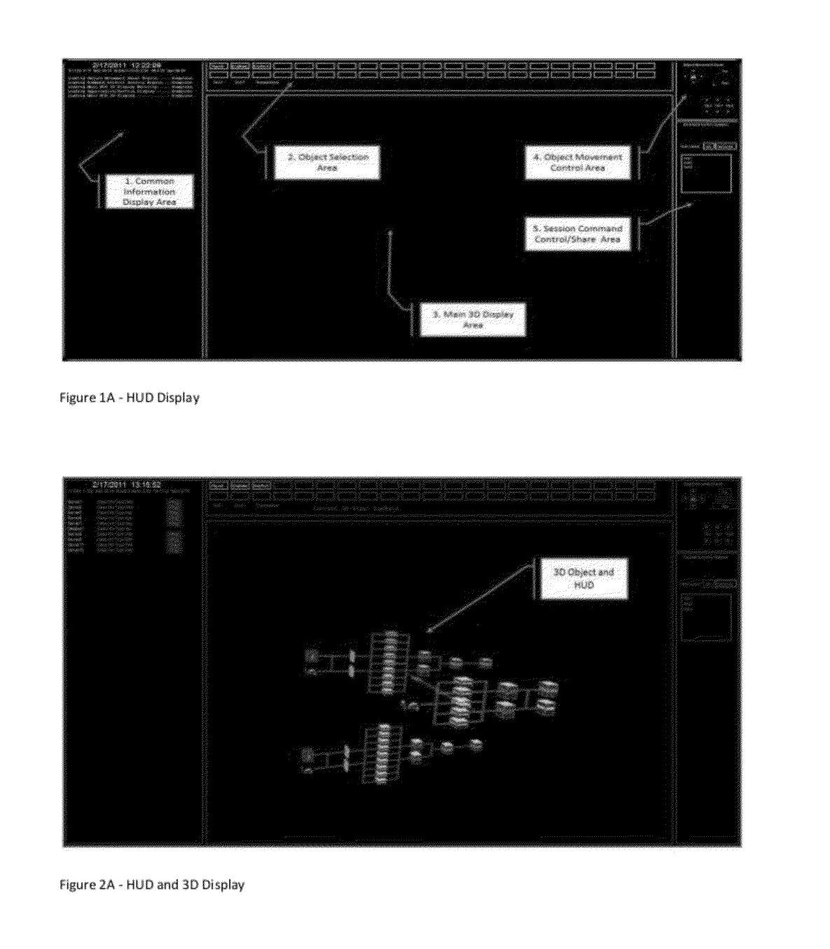

See FIG. 1A—HUD Display—in the Drawings file

Screen image 2A shows the HUD (as described in FIG. 1A) with a 3D object rotating behind it. Objects may be viewed as initially displayed or the user may choose to move the object closer, farther away, left, right, up, down or re-position around the ‘X’, ‘Y’ or ‘Z’ axis. This viewing capability allows the user to view the object from any direction or angle. Critical information is certainly displayed within the HUD, but on the objects themselves as well as the relationship between the objects.

Relationships between objects are depicted using lines and indicate ‘to/from’ types of dependency relationships. An algorithm is included in this design to map the display based on which objects communicate with which objects. It will dynamically render the 3D structure based on this relationship information. Therefore, the X, Y & Z coordinates are established programmatically based on the input data stream.

Objects within the input data stream may be IT infrastructure (servers, network devices, application, services, etc . . . ) or processes (infrastructure, operational, business, etc . . . ).

See FIG. 2A—HUD and 3D Display—in the Drawings file

Screen image 3A shows how the 3D image can be moved closer to the user and illustrates the function of the HUD to display information without obstructing the view of the 3D image. Having complete control of the rotating image (rotation can also be controlled in terms of direction and speed) allows the user to view all the defined aspects of the objects and their relationships.

‘Hovering’ the mouse over text displayed on the HUD will either remove or display additional information to the user as well as controlling the position/movement of the objects. Additionally, the 3D objects themselves can be ‘highlighted’ or will change aspects based on the mouse location over data on the screen.

See FIG. 3A—Show 3D object through HUD—in the Drawings file

Screen image 4A shows how the 3D objects can be displayed without the HUD being visible. This viewing capability reduces the data displayed and allows for the full screen to be completely utilized for 3D images.

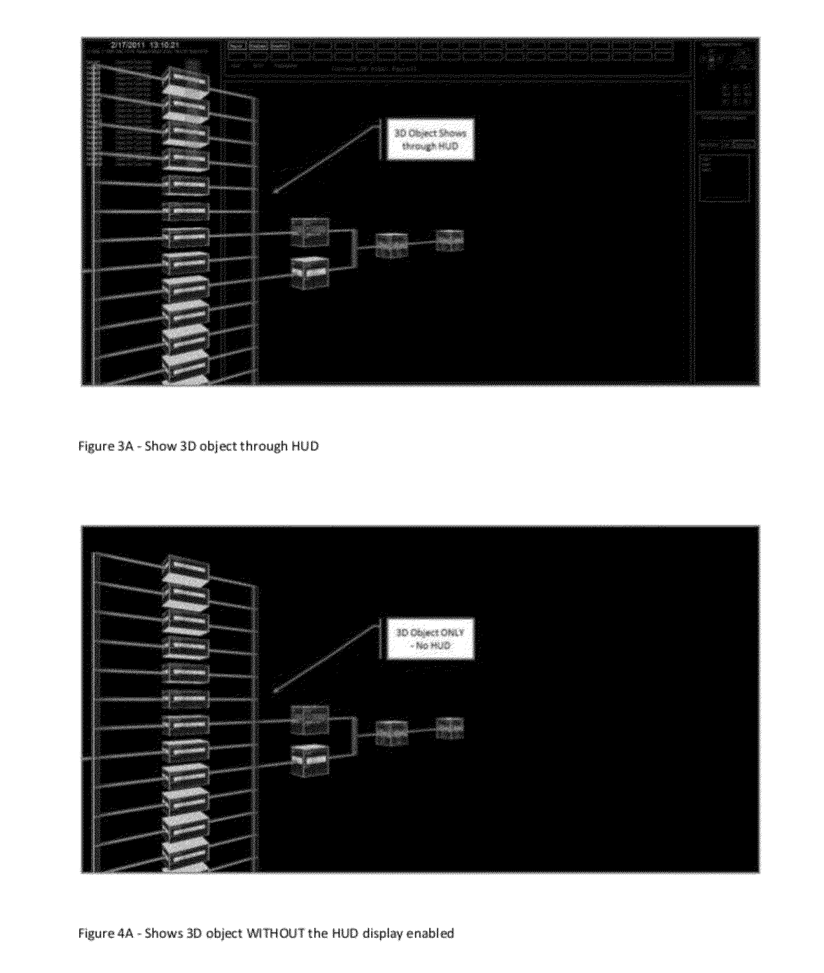

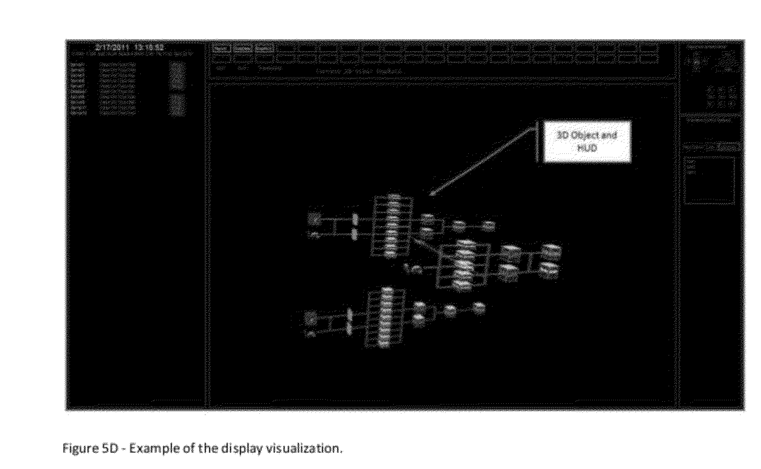

See FIG. 4A—Shows 3D object WITHOUT the HUD display enabled—in the Drawings file

### DETAILED DESCRIPTION OF THE INVENTION

While 3D visualization is common within numerous other environments (like Movies, Gaming, Traffic reports, Weather reports, etc . . . ) it has only been utilized in the Information Technology (IT) space in so far as displaying virtual rooms or virtual physical environments (i.e. datacenter) and the IT equipment contained in that room. That focus of display may be valuable in some respects; however it is completely different from the concept proposed in this patent. This patent application focuses on a display of the application/service topology in a spatial environment much like a satellite floating in space. The topology is rendered as a collection of configuration items that form a holistic object (aka Application or Service).

Various technologies are utilized to enable this web or browser based interface. This invention utilizes the independent technologies to enable the presentation layer logic. However, it is the underlying engine (substance of this invention) that determines the screen layout, position of 3D objects, movement of the objects as well as the dynamic positions of objects in relationship to one another. The Engine reads all of the objects (CI's) from a configuration management database (CMDB) or other sources of data, determines the TO and FROM relationships of each object, then organizes the objects in a liner row based on the TO/FROM data while connecting each object to dependent objects via 3D lines. FIG. 5D below illustrates a topology rendered automatically based solely on the input of individual CI objects. The position on the screen of each object was programmatically determined and connecting lines drawn to indicate relationships.

See FIG. 5D—Example of the display visualization—in the Drawings file.

CI Objects may be represented as ‘cubes’ or other shapes with textured images on all sides. These textures indicate data such as operating system software/versions, current status, type of connection, etc.

1. While 3D visualization is common within numerous other environments (like Movies, Gaming, Traffic reports, Weather reports, etc . . . ) it has only been utilized in the Information Technology (IT) space in so far as displaying virtual rooms or virtual physical environments (i.e. datacenter) and the IT equipment contained in that room.
The ‘virtual physical environments’ display may be valuable in some respects; however it is completely different from the concept proposed in this patent.
This patent application focuses on a display of the application/service topology in a spatial environment much like a satellite floating in space. The topology is rendered as a collection of configuration items that form a holistic object. The holistic object can represent a collection such as an Application or Service.
This patent also incorporates the use of a Heads-up Display (HUD) to provide movement control of 3D objects, display of extensive data related to objects, selection of objects and the collaborative session control facility.
This patent includes the programmatically determining engine to place objects into position on the virtual screen without each CI providing its own coordinates. The coordinates are determines and enhanced as each new object is added to the mix. Objects are grouped and regrouped based on the class and relationships of objects.
This patent includes the facility to allow for collaboration between two or more people where a common view is shared, a single user controls the view of all attached users—thus enabling everyone to see the same view. This shared view includes constant updates as the controlling users is rotating the view, highlighting items on the HUD or making selections on the HUD with their mouse.
